(19) United States
(12) Patent Application Publication
(10) Pub. No.: US 2024/0308171 A1
(43) Pub. Date: Sep. 19, 2024

(54) Drying Oil Interlocking Layer

(71) Applicants: Walter J. LEWICKI, JR., Lancaster, PA (US); William J. KAUFFMAN, Manheim, PA (US)

(72) Inventors: Walter J. LEWICKI, JR., Lancaster, PA (US); William J. KAUFFMAN, Manheim, PA (US)

(21) Appl. No.: 18/183,212

(22) Filed: Mar. 14, 2023

(51) Int. Cl. B32B 3/06; B32B 9/02

(52) U.S. Cl. CPC B32B 3/06; B32B 9/02; B32B 2307/732; B32B 2471/00; B32B 2607/02

(57) ABSTRACT

This invention describes the manufacture of a core layer comprising a polymerized drying oil and interlocking edge detail which allows multiple core layers to be installed and connected through the edge detail. In one embodiment, the core layer further comprises at least one co-reacted multi-functional co-vulcanizing agent. Additionally, a structure comprising the core layer with interlocking edges having a decorative flooring layer laminated to the top surface is described. The decorative flooring layer can comprise a linoleum layer.

### FIELD OF THE INVENTION

The invention is directed to forming a core layer comprising polymerized natural drying oil that further comprises interlocking edge detail. Adhering linoleum layers to this core layer produces a natural based product that can be installed by interlocking edges . . .

### BACKGROUND OF THE INVENTION

Natural drying oils have found utility in linoleum flooring products, and coatings for furniture. Drying oils harden/cure after a period of exposure to air. The oil hardens through a chemical reaction in which the components crosslink by action of oxygen-air oxidation. Drying oils include but are not limited to natural oils such as linseed oil, Tung oil, sunflower oil, walnut oil, poppy oil, perilla oil, and air drying synthetic alkyd resins. These materials are utilized in coatings, paints, printing inks and flooring.

For example, the manufacture of Linoleum flooring involves partially air oxidizing linseed oil until a select viscosity is obtained. This oxidation is done at elevated temperature and takes significant time to reach the desired viscosity. This partially pre-oxidized/partially cured material is called Linoxyn.

Linoleum cement comprises Linoxyn and rosin. Traditionally linoleum cement is compounded with fillers and pigments and subsequently consolidated into solid layer, typically on a backing material to form a flooring structure. Traditionally, the linoleum composition comprises wood flower, cork, and calcium carbonate powder. At this stage, the flooring does not possess the desired physical properties and needs to be further oxidatively cured by “stoving” at slightly elevated temperature in circulating air. This curing process takes considerable time such as 2-4 weeks before desired properties are obtained.

Linoleum made in the 1950s and 1960s was mostly single colors of beige, gray, blue or red, currently linoleum is available in numerous decors, patterns and rich design. It can contain a top print as well. A clear surface layer is applied overlying the print for enhancing chemical and physical performance properties.

The performance characteristics of traditional linoleum like Luxury Vinyl floor products have been upgraded to include clear high performance surface coatings including but not limited to formulations containing uv-curable acrylic, polyurethane, polyester materials and combinations thereof. Sometimes extremely fine particles such as aluminum oxide, quartz, or industrial diamonds are part of the cured surface layer as well. The introduction of UV LED light curing lamps has enabled the application of high performance coatings on thermo sensitive materials such as linoleum.

Traditional linoleum layers are not dimensionally stable under variable humidity conditions due to the hydrophilic components. US 2016/0102465 teaches the addition of hydrophobic waxes to improve stability.

Flooring products such as Rigid Core Luxury Vinyl Plank & Tile, Nova floor by Novalis Innovative Flooring, and Pergo Wood Laminate composites have been developed that contain a stable core layer that comprises interlocking edge detail; a requirement for joining additional pieces to construct a full floor surface. Core materials for use in “clic” together flooring may include but are not limited to PVC with high filler content, SPC, WPC and HDF (both standard and waterproof types). These have found acceptance in the market place.

Linoleum floating floor products (planks & tiles) have been produced by applying a linoleum top layer onto water proof HDF core having interlocking edges. For example, Forbo Marmoleum Click Cinch Lock, and Nova Distinctive Floors Linoleum Floating Floor contain glueless clic together edge detail.

Traditional linoleum material in tile or other modular forms is not sufficiently stable with interlocking edges for a composite structure to perform as flooring. Most of these smaller sizes contain woven interlayers for stability, contain no interlocking edge detail and are glued to a more stable non linoleum backing or directly to a subfloor for all adjacent pieces to form an acceptable linoleum floor. There is a need for such a product comprising a core layer with interlocking edges based on natural drying oils.

### SUMMARY OF THE INVENTION

This invention describes the structure and manufacture of a core layer comprising a natural drying oil, wherein the core layer further contains physical interlocking edges.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

The detailed description set forth below is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

All percentages and ratios are calculated by weight unless otherwise indicated. All percentages are calculated based on the total weight of a composition unless otherwise indicated. All component or composition levels are in reference to the active level of that component or composition, and are exclusive of impurities, for example, residual solvents or by-products, which may be present in commercially available sources.

Exemplary embodiments of the present invention are now described. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

This invention describes the manufacture of a core layer based upon modification of drying oils. Drying oils harden after a period of exposure to air. The oil hardens through a chemical reaction in which the components crosslink by action of oxygen-air oxidation. Drying oils include but are not limited to natural oils such as linseed oil, Tung oil, sunflower oil, walnut oil, poppy oil, perilla oil, and drying synthetic alkyd resins. Typically, these drying oils are partially reacted with oxygen until a desired viscosity is achieved-polymer binder. In some embodiments this invention comprises the addition of a polyfunctional reactive co-vulcanizing agent with the natural drying oil. Through a series of process steps, these materials react significantly producing a cured core layer that can form interlocking edges.

The ability of the core layer to be shaped and maintain its interlocking edges defines required machinability of the layer. The core layer can be formed and maintains interlocked edges between two adjacent core layers, under variable room conditions such as humidity and temperature.

Additionally, the multi-functional co-vulcanizing agent can be self-reacted under radical conditions if oxygen is not present. Non-limiting examples of co-vulcanizing agents include triallyl cyanurate, triallyl isocyanurate, trimethanolpropane triallyl ether, pentaerythritol tetra allyl ether, or other materials that include an activated alpha methylene group adjacent a peroxide curable double or triple bond. These can be monomeric or polymeric in nature, for example natural or synthetic rubber. Additionally other reactive monomers can be utilized if oxygen is not present. For example, removing oxygen from the natural drying oil and adding a radical generator such as peroxide under nitrogen allows for multi-functional acrylates or methacrylates to co-react with the drying oil when heated.

Additionally, a blowing agent can be included in the formulation to reduce the density of the core layer if desired. The use of a blowing agent in the core layer for a wall covering is advantageous for both low weight and cost considerations.

In one embodiment, a core layer can be produced by reacting the drying oil with co-vulcanizing agent utilizing a peroxide radical generator without the presence of oxygen. Subsequently a second peroxide can be added, fillers, pigments and other ingredients added. A layer is formed and heated at temperature of decompose the second peroxide to cure the layer. In one embodiment the second peroxide is dicumyl peroxide. It is understood that the second peroxide may be the same peroxide as used in the initial reaction of drying oil and co-vulcanizing agent depending upon process conditions required.

In another embodiment, a core layer can be produced by reacting the drying oil with co-vulcanizing agent without oxygen being present (as above) and subsequently be compounded with siccative, fillers, pigments, and a second peroxide. Forming the layer and heating and curing occurs in the presence of oxygen. Depending upon co-vulcanizing agent selected the second peroxide may not be needed.

In yet another embodiment, a core layer can be produced by reacting the drying oil with the co-vulcanizing agent under siccative oxidative conditions. This can be done with or without adding a radical generator such as peroxide.

The options for reacting the drying oil with a co-vulcanizing agent are described in U.S. Pat. Nos. 10,875,971 and 9,518,198. Additionally, the core layer can be produced by utilizing polymer blends as defined in U.S. Pat. No. 10,947,406. These are included in their entirety.

In another embodiment the core layer composition comprises hydrophobic fillers including but not limited to talc, graphite, molybdenite, bentonite, fly ash, expanded vermiculite and perlite, silica and surface treated calcium carbonate. Hydrophobic fibers can also be utilized in the composition. Hydrophobic fibers include but are not limited to: glass, mineral, carbon nanofiber, polyester, nylon, polyolefin and similar polymer types. These include hydrophobic polymer types such as polyethylene, polyvinylchloride, polyethylene terephthalate, polyurethane, polytetrafluorethylene, polydimethylsiloxane, and polypropylene.

The core layer of the invention can be produced by conventional means including extrusion, calendering, roll/press consolidation, or double belted press processes. These and similar manufacturing methods are known to those skilled in the art. During the core forming process, a blowing agent which can be added during the prior mixing process can be activated to form air pockets within the core. Alternately, the blowing agent can be activated later in the process such as during the cure of the linoleum core layer.

Formation of interlocking edges is accomplished by traditional machining means. The core layer can be used in the manufacture of flooring and wall covering.

In one embodiment, the core layer is monochromatic.

In another embodiment, a composite structure comprises a stiff core layer and at least one additional layer adjacent to the core layer. In another embodiment, the composite structure comprises the stiff core layer, a backing layer and a top layer. In these composite structures, the physical and mechanical properties and thickness of the core layer should be the main contributors to the dimensional stability of the composite structure. Thickness of the core layer can be about 2-4 mm in thickness, preferably around 4 mm. Required thickness of the core layer depends on the thickness and physical and mechanical properties of the adjacent layers and the end product to be made. The end product can be a flooring or a wall covering material. It is understood that the end product can also have a textured/embossed appearance.

In another embodiment, an installed product comprising multiple composite structures having the core layer is produced, wherein the product is installed by interlocking the edges of the composite structures. The installed product can be a flooring or wall covering.

Backing layer can comprise solid or foamed material, including but not limited to those based on natural drying oil, polyurethane, polyester, acrylic, natural and synthetic rubber, cork, polyurethane, polyester, polyvinyl chloride, acrylics, and polyolefin materials; including IXPE (Irradiated Cross-Linked Polyethylene) foam. Also, backing materials can be made of biodegradable plastics. In one example of a flooring product, a 1 mm thick layer of cork or foam backing layer provides for additional under foot comfort, accommodates more subfloor irregularities and provides sound deadening characteristics.

Depending on the product requirements, a backing layer may not be required for all decorated linoleum coverings. For example, a core layer having interlocking edge detail with an adjacent decorated surface plus a clear protective overlayer might be sufficient for a wall covering. It is well known by those skilled in the art, that many variations can be made for a wall covering containing a layer made as fore mentioned in the specification that would provide many different properties for residential and commercial wall coverings.

In yet another embodiment, a composite wall covering structure comprises a core layer with interlocking edges and at least one additional decorative layer and a clear overlay to provide good surface cleanability and scratch resistance. Two or more of the decorative wall covering tile, planks or pieces are enjoined through engaging their interlocking edges. Once the enjoined pieces of wall covering are positioned for the overall design for the interior wall, the decorative wall covering is pressed into place using any number of adhesive types.

For one skilled in the art, the invented product can be adhered to almost any interior wall surface. U.S. Pat. No. 4,791,015 describes one such adhesive method for this application. During the manufacturing process, an adhesive plus release paper is applied to the backside of the core layer. The release liner is removed from the back of the tile/planks and pressed against the wall.

Any number of available adhesives or adhesive types, can hold the product in place with excellent performance. If the walls move with humidity, the product will float over the wall without losing its bond. Also, recent advancements in adhesive technology allow for enjoined core layers of this invention to be easily adhered to many different wall surfaces; are repositionable, and fully removeable without damage to either the back of the product or to the wall surface to which they were originally adhered. For example, 3M's Command wall hanging strips and special double sided frame hanging strips/tapes are available in the market

In another embodiment a decorative layer can be adhered to the top surface of the core layer. This includes a traditional linoleum layer.

In another embodiment, the core layer comprises a visual decorative layer. Additionally the core layer having a decorative effect can also comprise a transparent surface layer overlying the decorative layer. In one embodiment, the decorative layer is achieved by printing techniques. The printed decorative layer can comprise an ink that contains foaming inhibitor.

In yet another embodiment, a backing layer is applied to the adjacent side of the core layer opposite to the decorative layer wherein the decorative layer further comprises an overlying transparent surface layer.

The transparent layer overlying the decorative layer can be a clear high performance layer as known in the art. Additionally, the transparent layer can be a composite layer comprising a clear layer and an overlying high performance surface layer, such as a UV curable coating. It is possible to utilize a back printed film as the decorative layer further comprising a high performance surface layer on the opposite side of the print. These composite transparent layers are known in the art, and can have different surface gloss levels and inorganic additives.

In one example, 20% triallylisocyanurate (TAIC) was co-reacted with linseed oil in the presence of rosin under oxidative siccative conditions, no peroxide present. After compounding and air curing the resulting linoleum layer was significantly stiffer than a control layer. The resulting layer having TAIC was then subjected to machining conditions and a mechanical edge detail was achieved.

In general, the co-vulcanizing agent can be added from 20% up to 50% by weight of the drying oil depending upon the co-vulcanizing agent's composition and processing conditions. In various illustrative embodiments the co-vulcanizing agent is at least around at least around 20%, at least around 25%, at least around 30%, at least around 35%, at least around 40%, at least around 45%, at least around 50%, by weight of the drying oil. One embodiment has the co-vulcanizing agent at a 20%-30% level. Depending upon co-vulcanizing agent selected, the level of co-vulcanizing agent utilized determines the stiffness and machinability of the final cured layer, as well as stability under variable humidity conditions.

In one embodiment, rosin is present during the reaction of drying oil and co-vulcanizing agent.

If the core layer comprises a polymer blend, the amount of polymerized natural oil required depends upon the physical and mechanical properties of the co-blended polymer.

While the invention has been described with reference to an illustrative embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. A core layer comprising polymerized natural oil and interlocking edge detail.

2. The core layer of claim 1, wherein the natural oil is linseed oil.

3. The core layer of claim 1, wherein the composition of the core layer comprises hydrophobic materials.

4. The core layer of claim 1, wherein the thickness of the core layer is around 2 mm to around 4 mm.

5. The core layer of claim 1, wherein the composition of the core layer comprises a blowing agent.

6. A core layer comprising polymerized natural oil, and polymerized co-vulcanizing agent and interlocking edge detail.

7. The core layer of claim 6, wherein the composition of the core layer comprises hydrophobic materials.

8. The core layer of claim 1, wherein the interlocking edge detail enjoins two or more core layers.

9. The core layer of claim 6, wherein the interlocking edge detail enjoins two or more core layers.

10. A composite structure comprising the core layer of claim 1, and at least one additional adjacent layer.

11. A composite structure comprising the core layer of claim 6, and at least one additional adjacent layer

12. The composite structure of claim 10, wherein the adjacent layer is a layer of linoleum.

13. The composite structure of claim 11, wherein the adjacent layer is a layer of linoleum.

14. The composite structure of claim 10, wherein the adjacent layer is a decorative layer.

15. The composite structure of claim 11, wherein the adjacent layer is a decorative layer.

16. The composite structure of claim 14, wherein the decorative layer is a printed layer.

17. The composite structure of claim 15, wherein the decorative layer is a printed layer.

18. The composite structure of claim 14, further comprising a transparent layer overlying the decorative layer.

19. The composite structure of claim 15, further comprising a transparent layer overlying the decorative layer.

20. A composite structure comprising the core layer of claim 1, and a backing layer and a top decorative layer and a transparent surface layer overlying the decorative layer.

21. A composite structure comprising the core layer of claim 6, and a backing layer and a top decorative layer and a transparent surface layer overlying the decorative layer.

22. An installed product comprising multiple composite structures of claim 10, wherein the product is installed by interlocking the edges of the composite structures.

23. An installed product comprising multiple composite structures of claim 11, wherein the product is installed by interlocking the edges of the composite structures.

24. The installed product of claim 22, wherein the product is a floor covering.

25. The installed product of claim 22, wherein the product is a wall covering.

26. The installed product of claim 23, wherein the product is a floor covering.

27. The installed product of claim 23, wherein the product is a wall covering.
